(19) United States
(12) Patent Application Publication
(10) Pub. No.: US 2023/0368628 A1
(43) Pub. Date: Nov. 16, 2023

(54) CIGARETTE SMOKE ALARM DEVICE FOR NON-SMOKING SPACE

(71) Applicant: Man-Chee LIU, Taipei City (TW)

(72) Inventor: Man-Chee LIU, Taipei City (TW)

(21) Appl. No.: 17/829,829

(22) Filed: Jun. 1, 2022

(30) Foreign Application Priority Data
May 13, 2022 (TW) 111204958

(51) Int. Cl. G08B 13/196; G08B 17/12; H04N 5/33

(52) U.S. Cl. CPC G08B 13/196; G08B 17/125; H04N 5/33

(57) ABSTRACT

A cigarette smoke alarm device for non-smoking space, including: a thermal image sensing unit, which includes an infrared sensing array for sensing a thermal image in a non-smoking space; and an image processing circuit coupled with the thermal image sensing unit to receive the thermal image, the image processing circuit including a control unit, a memory and a communication interface, and the control unit being coupled with the memory and the communication interface, where the memory is used to store the thermal image, and the control unit is used for performing a smoke image evaluation operation on the thermal image to generate a detection result of a smoking event, and transmitting a data signal representing the detection result to an external device through the communication interface.

### BACKGROUND OF THE INVENTION

### Field of the Invention

The present invention relates to a smoke detection device, especially to a cigarette smoke alarm device for non-smoking space.

### Description of the Related Art

Generally, indoor spaces are equipped with smoke detectors to provide a fire warning function, so as to extinguish fires and evacuate people early.

However, for some indoor spaces, conventional smoke detectors cannot detect general cigarette smoking events unless the indoor space is airtight and there are many people smoking together in the indoor space. This will cause troubles to the management of non-smoking spaces, especially for hotel operators. If the cigarette smoking events in the non-smoking rooms cannot be stopped immediately, the non-smoking rooms will be tainted with smoke smell and may be frequently rejected by non-smoking guests.

To solve the above-mentioned problems, a novel cigarette smoke alarm device is urgently needed.

### SUMMARY OF THE INVENTION

One objective of the present invention is to provide a cigarette smoke alarm device for non-smoking space, which can automatically determine whether there is a cigarette smoking event in a non-smoking space according to a thermal image of the non-smoking space.

Another objective of the present invention is to provide a cigarette smoke alarm device for non-smoking space, which can automatically determine whether there is an electronic cigarette smoking event in a non-smoking space according to a thermal image of the non-smoking space.

To attain the aforementioned objectives, a cigarette smoke alarm device for non-smoking space is proposed, which includes:
a thermal image sensing unit, which includes an infrared sensing array for sensing a thermal image in a non-smoking space; and
an image processing circuit coupled with the thermal image sensing unit to receive the thermal image, the image processing circuit including a control unit, a memory and a communication interface, and the control unit being coupled with the memory and the communication interface, where the memory is used to store the thermal image, and the control unit is used for performing a smoke image evaluation operation on the thermal image to generate a detection result of a smoking event, and transmitting a data signal representing the detection result to an external device through the communication interface.

In one embodiment, the control unit is a microprocessor.

In one embodiment, the communication interface is a network interface.

In one embodiment, the communication interface is a WiFi interface.

In one embodiment, the external device is a server.

In one embodiment, the smoking event is a cigarette smoking event.

In one embodiment, the smoking event is an electronic cigarette smoking event.

In one embodiment, the image processing circuit further includes a sound warning device, and the control unit is coupled to the sound warning device to drive the sound warning device to generate a warning sound when the detection result is positive.

In one embodiment, the smoke image evaluation operation includes an artificial intelligence module.

In one embodiment, the artificial intelligence module is a pre-trained neural network module.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 illustrates a block diagram of a cigarette smoke alarm device for non-smoking space according to an embodiment of the present invention.

### DETAILED DESCRIPTION OF THE PREFERRED EMBODIMENTS

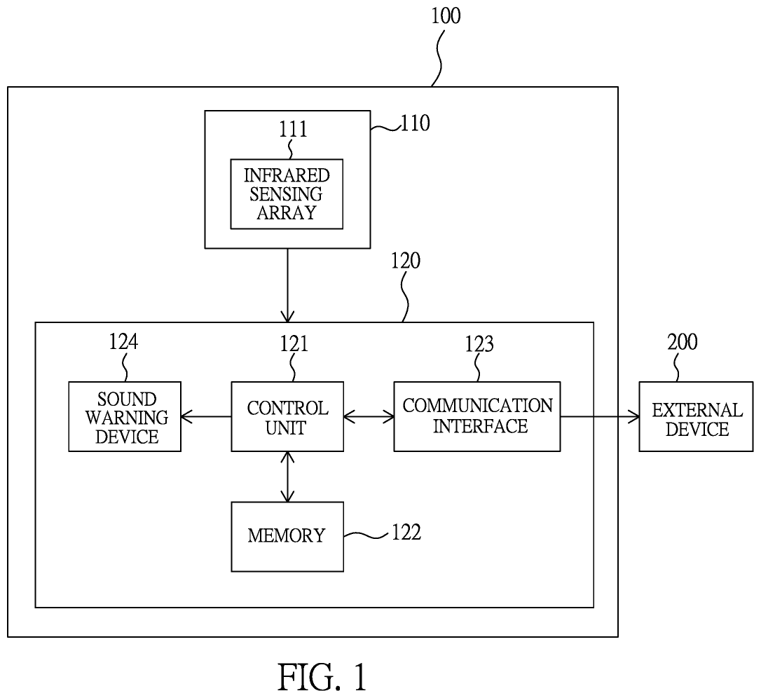

Please refer to FIG. 1, which illustrates a block diagram of a cigarette smoke alarm device for non-smoking space according to an embodiment of the present invention. As illustrated in FIG. 1, a cigarette smoke alarm device 100 includes a thermal image sensing unit 110 and an image processing circuit 120.

The thermal image sensing unit 110 includes an infrared sensing array 111 to sense a thermal image of a non-smoking space.

The image processing circuit 120 is coupled with the thermal image sensing unit 110 to receive the thermal image, and includes a control unit 121 and a memory 122, a communication interface 123 and a sound warning device 124. The control unit 121 is coupled with the memory 122, the communication interface 123 and the sound warning device 124, where the memory 122 is used to store the thermal image, and the control unit 121 is used to perform a smoke image evaluation operation on the thermal image to generate a detection result of a smoking event, and transmit a data signal representing the detection result to an external device 200 via the communication interface 123.

In addition, the control unit 121 can be a microprocessor; the communication interface 123 can be a network interface or a WiFi interface; and the external device 200 can be a server.

In addition, in the present invention, the smoking event may be a cigarette smoking event or an electronic cigarette smoking event.

In addition, the control unit 121 can drive the sound warning device 124 to generate a warning sound when the detection result is positive.

In addition, the smoke image evaluation operation may include an artificial intelligence module, and the artificial intelligence module may be a pre-trained neural network module. As both the cigarette smoke and the electronic cigarette smoke can be sensed by the infrared sensing array 111, the thermal images of a space having a smoking event can therefore be used to train the artificial intelligence module to build up an ability of identifying the smoke event by processing at least one sensed thermal image. Besides, as the shape of the smoke generated in a cigarette smoking event is different from the shape of the smoke generated in an electronic cigarette smoking event, the trained artificial intelligence module of the present invention can therefore effectively discriminate these two different kinds of smoking events.

As can be seen from the above description, the present invention can offer the following advantages:
1. The cigarette smoke alarm device for non-smoking space of the present invention can automatically determine whether there is a cigarette smoking event in a non-smoking space according to a thermal image of the non-smoking space.
2. The cigarette smoke alarm device for non-smoking space of the present invention can automatically determine whether there is an electronic cigarette smoking event in a non-smoking space according to a thermal image of the non-smoking space.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

1. A cigarette smoke alarm device for a non-smoking space, including:
a thermal image sensing unit, which includes an infrared sensing array for sensing a thermal image in the non-smoking space; and
an image processing circuit coupled with the thermal image sensing unit to receive the thermal image, the image processing circuit including a control unit, a memory and a communication interface, and the control unit being coupled with the memory and the communication interface, where the memory is used to store the thermal image, and the control unit evaluates the thermal image to generate a detection result of a smoking event, and transmitting a data signal representing the detection result to an external device through the communication interface;
wherein the infrared sensing array of the thermal image sensing unit is coupled with the control unit, the memory and the communication interface of the image processing circuit.

2. The cigarette smoke alarm device for non-smoking space as disclosed in claim 1, wherein the control unit is a microprocessor.

3. The cigarette smoke alarm device for non-smoking space as disclosed in claim 1, wherein the communication interface is a network interface.

4. The cigarette smoke alarm device for non-smoking space as disclosed in claim 1, wherein the communication interface is a WI-FI® interface.

5. The cigarette smoke alarm device for non-smoking space as disclosed in claim 1, wherein the external device is a server.

6. The cigarette smoke alarm device for non-smoking space as disclosed in claim 1, wherein the smoking event is a cigarette smoking event.

7. The cigarette smoke alarm device for non-smoking space as disclosed in claim 1, wherein the smoking event is an electronic cigarette smoking event.

8. The cigarette smoke alarm device for non-smoking space as disclosed in claim 1, wherein the image processing circuit further comprises a sound warning device, and the control unit is coupled with the sound warning device to drive the sound warning device to generate a warning sound when the detection result is positive.

9-10. (canceled)
